(19) United States
(12) Patent Application Publication
(10) Pub. No.: US 2010/0192162 A1
(43) Pub. Date: Jul. 29, 2010

(54) METHOD AND APPARATUS FOR PROVIDING CALENDAR CONFLICT WARNINGS

(75) Inventors: Forest Mathew Conner, Mountain View, CA (US); Purva Upasak, Sunnyvale, CA (US)

Correspondence Address: Patent Capital Group - Cisco, 6119 McCommas, Dallas, TX, 75214, US

(73) Assignee: Cisco Technology, Inc., San Jose, CA (US)

(21) Appl. No.: 12/358,473

(22) Filed: Jan. 23, 2009

(51) Int. Cl. G06F 9/46

(52) U.S. Cl. 719/318

(57) ABSTRACT

In one embodiment, a method includes obtaining a transmission sent by a first application and determining whether the transmission includes date/time information. If it is determined that the transmission includes date/time information, the date/time information is compared to information associated with at least a second application. A determination is made as to whether the date/time information conflicts with the information associated with the second application, and if it is determined that the date/time information conflicts with the information associated with the second application, a conflict warning is provided.

### BACKGROUND OF THE INVENTION

The present invention relates generally to networking solutions.

Calendar applications are often used by individuals to keep track of their schedules because the calendar applications include functionality that allows the individuals to be notified of impending events. By way of example, if an individual has an appointment that is indicated in a calendar application, the calendar application may display an appointment reminder to the individual at some time before the appointment.

Even when an individual diligently maintains a calendar, e.g., a networked calendar, he or she may inadvertently schedule conflicting events, or two events which occur at the same time. An individual may, for instance, maintain a work calendar which includes work-related activities and a personal calendar which includes personal activities. When more than one separate calendar is maintained by an individual, the individual may unwittingly schedule more than one event for the same time because a time slot appears available on one calendar, when the time slot is indicated as being unavailable on another calendar. That is, an individual may schedule an event at a particular time because the particular time appears to be available on one of his or her calendars, when the particular time is actually not available because the particular time is booked on another or of his or her calendars.

Many issues may arise when an individual inadvertently schedules events at substantially the same time, i.e., conflicting events. Aside from being physically unable to attend two events at substantially the same time, other issues which may arise include forfeiting sums of money, e.g., money paid for the conflicting events.

### BRIEF DESCRIPTION OF THE DRAWINGS

The invention will be readily understood by the following detailed description in conjunction with the accompanying drawings, wherein like reference numerals designate like structural elements, and in which:

FIG. 1A is a diagrammatic representation of a system in which a calendar application provides calendar conflict warnings in accordance with an embodiment of the present invention.

FIG. 1B is a diagrammatic representation of a system in which a calendar conflict application daemon communicates with at least one calendar application and provides calendar conflict warnings in accordance with an embodiment of the present invention.

FIG. 2 is a diagrammatic representation of a process of providing a calendar conflict warning in accordance with an embodiment of the present invention.

FIG. 3 is a process flow diagram which illustrates a method of processing transmissions from a browser application from the point-of-view of a calendar conflict application in accordance with an embodiment of the present invention.

FIG. 4A is a diagrammatic representation of a browser application for which a conflict warning is provided as a pop-up field when a date/time field is activated by a mouse-over in accordance with an embodiment of the present invention.

FIG. 4B is a diagrammatic representation of a browser application for which a conflict warning is provided as a pop-up substantially in a toolbar in accordance with an embodiment of the present invention.

FIG. 4C is a diagrammatic representation of a browser application for which a conflict warning is provided as a pop-up window in accordance with an embodiment of the present invention.

FIG. 5 is a block diagram representation of transmission from a browser application to a server.

FIG. 6 is a process flow diagram which illustrates a method of processing date/time data included in a transmission in accordance with an embodiment of the present invention.

FIG. 7 is a process flow diagram which illustrates a method of configuring a calendar conflict daemon in accordance with an embodiment of the present invention.

### DESCRIPTION OF EXAMPLE EMBODIMENTS

### General Overview

According to one aspect of the present invention, a method includes obtaining a transmission sent by a first application and determining whether the transmission includes date/time information. If it is determined that the transmission includes date/time information, the date/time information is compared to information associated with at least a second application. A determination is made as to whether the date/time information conflicts with the information associated with the second application, and if it is determined that the date/time information conflicts with the information associated with the second application, a conflict warning is provided.

### Description

Individuals are often inconvenienced when they inadvertently schedule two events or appointments which occur at substantially the same time. Double-booking dates and/or times leads to event scheduling issues which may be difficult to resolve. A system which warns an individual before he or she is able to schedule an event that conflicts with an already scheduled event may prevent the scheduling of two conflicting events. If an individual is warned before he or she schedules a conflicting event, he or she may avoid the inconvenience of dealing with two events which are scheduled at substantially the same time.

When an individual is interacting or otherwise using a browser application to schedule an event at a particular time, he or she is warned that his or her calendar already has an event scheduled at that particular time. In one embodiment, an application may identify when the browser application is being used to potentially schedule an event at a particular time, access at least one calendar maintained by or for the individual to determine whether there is already an event scheduled at that particular time, and indicate to the individual that there is already an event scheduled at that particular time.

A calendar application or a standalone application may monitor a browser application, and parse output generated by the browser application to identify information which identifies a date and/or a time, e.g., date/time information. When date/time information is identified in output or, more generally, transmissions from a browser application, the calendar application or the standalone application may access a calendar to determine whether the date/time information indicates a conflict. That is, the calendar application or the standalone application may identify events scheduled in the calendar which overlap with or otherwise indicate a conflict with the date/time information. If a conflict with the date/time information is indicated, the calendar application or the standalone application may provide a warning of the conflict. Such a calendar conflict warning may effectively be provided to a user, i.e., a user of a browser application, to enable the user to make an informed decision regarding whether or not to proceed with scheduling an event that conflicts with an event already scheduled in his or her calendar. In other words, an individual may use a calendar warning to substantially avoid scheduling a conflicting event.

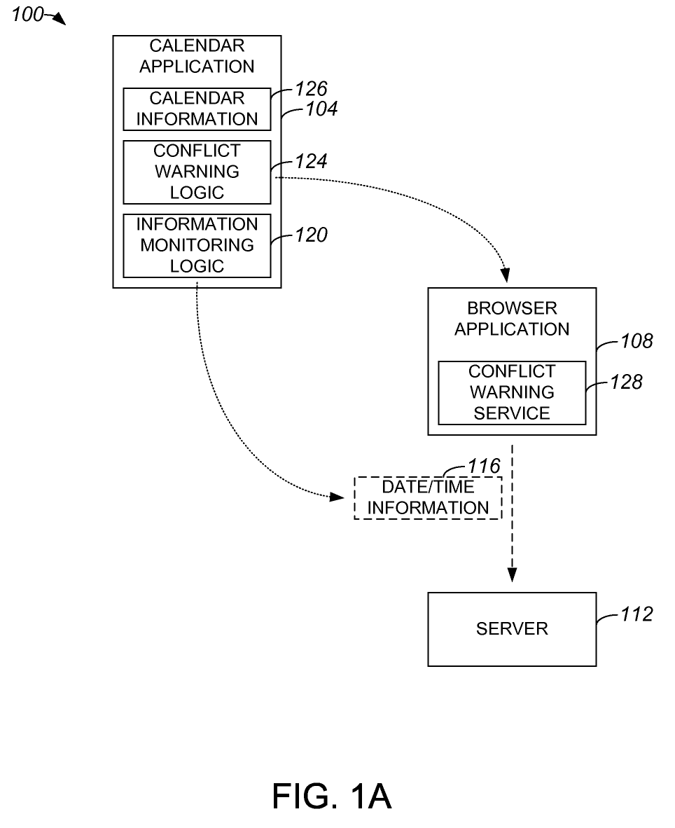

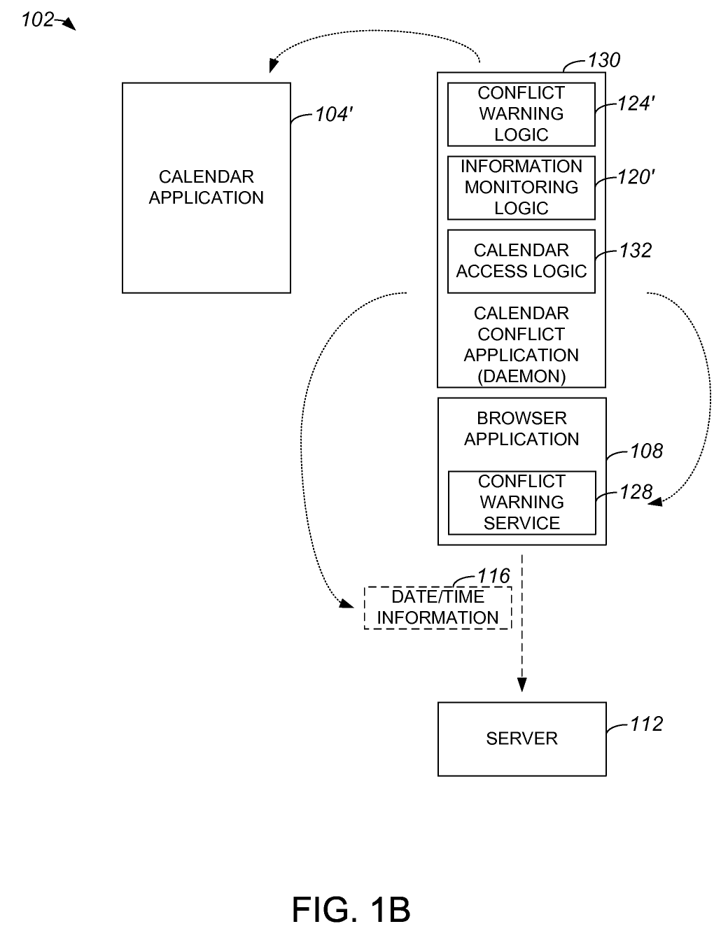

Calendar conflict warnings may be provided to a user, e.g., an individual who is interacting with a browser application to effectively schedule an event, in any suitable manner. By way of example, calendar conflict warnings may be provided by a calendar application or by a substantially standalone application. Such a calendar application or substantially standalone application may be provided on a desktop of a computing system used by a user. Referring initially to FIG. 1A, a system in which a calendar application is arranged to provide calendar conflict warnings will be described in accordance with an embodiment of the present invention. A system 100 includes a calendar application 104, a browser application 108, and a server 112. In one embodiment, system 100 is a networked system in which calendar application 104, browser application 108, and server 112 are located on separate computing systems. It should be appreciated, however, that substantially any combination of calendar application 104, browser application 108, and server 112 may be located on a shared computing system.

An individual (not shown) may interact with browser application 108 and, hence, cause browser application 108 to transmit information to server 112 over a communications channel. Browser application 108 may be a web browser which allows the individual to interact with information associated with system 100 or, more generally, a network such as the World Wide Web. Browser application 108 may be used to interact with any suitable arrangement which allows dates and/or times to be specified or selected. In one embodiment, browser application 108 may be used to access a website that has date and/or time information.

Server 112 is generally external with respect to browser application 108 in that information is transmitted between browser application 108 and server 112 over a communications channel that may be monitored by calendar application 104. By way of example, when date/time information 116 is transmitted by browser application 108, calendar application 104 may identify date/time information 116.

Calendar application 104, in the described embodiment, includes information monitoring logic 120 which monitors transmissions from browser application 108 to at least one server, e.g., server 112. Information monitoring logic 120 is arranged to identify transmissions that includes date/time information 11 6. For example, information monitoring logic 120 may effectively parse a hypertext transport protocol (http) request (not shown) transmitted by browser application 108 to identify date/time information 116 contained within the http request.

Once information monitoring logic 120 identifies date/time information 116, conflict warning logic 124 included in calendar application 104 compares date/time information 116 with calendar information 126 to determine whether a date and/or time specified by date/time information 116 is in conflict with calendar information 126. Calendar information 126 generally includes information relating to scheduled events, and effectively provides an indication of events already scheduled by an individual, i.e., an owner associated with calendar application 104. Calendar information 126 may include, but is not limited to including, a name or title of an event, a type associated with the event, a date or dates of the event, and a time or time range for the event.

If conflict warning logic 124 identifies a conflict, e.g., a date or time overlap, between date/time information 116 and calendar information 126, conflict warning logic 124 effectively provides browser application 108 with an indication that there is a conflict. For example, conflict warning logic 124 may send a message to browser application 108 which indicates that date/time information 116 is in conflict with calendar information 126. When such a message is received by browser application 108, a conflict warning service 128 may present the message to an individual. The message may be presented as a visual warning that there is a calendar conflict associated with date/time information 116. It should be appreciated that although browser application 108 is described as presenting calendar conflict information to an individual, substantially any application associated with a computing system (not shown) of the individual may be used to present the calendar conflict information.

In lieu of being included in a calendar application, the functionality to monitor transmissions from a browser application and to provide calendar conflict warnings may be included in a substantially standalone application or daemon which is in communication with a calendar application and a browser application. FIG. 1B is a diagrammatic representation of a system in which a calendar conflict application or daemon communicates with at least one calendar application and provides calendar conflict warnings in accordance with an embodiment of the present invention. A system 102 includes a calendar application 104′, a browser application 108, a server 112, and a calendar conflict application or daemon 130. System 102 may be a networked system or a local system, e.g., a system in which two or more of the components of system 102 are located on a computing system.

An individual (not shown) may interact with browser application 108 and, hence, cause browser application 108 to transmit date/time information 116 to server 112 over a communications channel. Calendar conflict application 130 is arranged to monitor the communications channel between browser application 108 and server 112, and to identify when date/time information 116 is transmitted by browser application 108.

Calendar conflict application 130 may include information monitoring logic 120′ which monitors transmissions from browser application 108 to server 112. Information monitoring logic 120′ is arranged to identify transmissions that includes date/time information 116. Conflict warning logic 124′, which is included in calendar conflict application 130, compares date/time information 116 with information obtained from calendar application 104′ to determine whether a date and/or time specified by date/time information 116 conflicts with information obtained from calendar application 104′. Typically, calendar access logic 132 obtains information from calendar application which may then be used by conflict warning logic 124′ to identify a conflict between date/time information 116 and scheduled events associated with calendar application 104′.

A conflict between date/time information 116 and scheduled events may be defined substantially as an overlap between date/time information 116 and scheduled events. As such, when a scheduled event occurs during a duration of time indicated in date/time information 116, or when date/time information 116 indicates an event that occurs during or at the same time as a scheduled event, a conflict may be identified.

If conflict warning logic 124′ identifies a conflict, conflict warning logic 124′ essentially notifies browser application 108 that date/time information 116 conflicts with an event identified in calendar application 104′. Conflict warning logic 124′ may send or otherwise provide a message to browser application 108 which indicates that date/time information 116 is in conflict with an event already scheduled on calendar application 104′. When a message is received by browser application 108 from calendar conflict application 130, a conflict warning service 128 may present the message to an individual, as for example as a visual warning that there is a calendar conflict associated with date/time information 116.

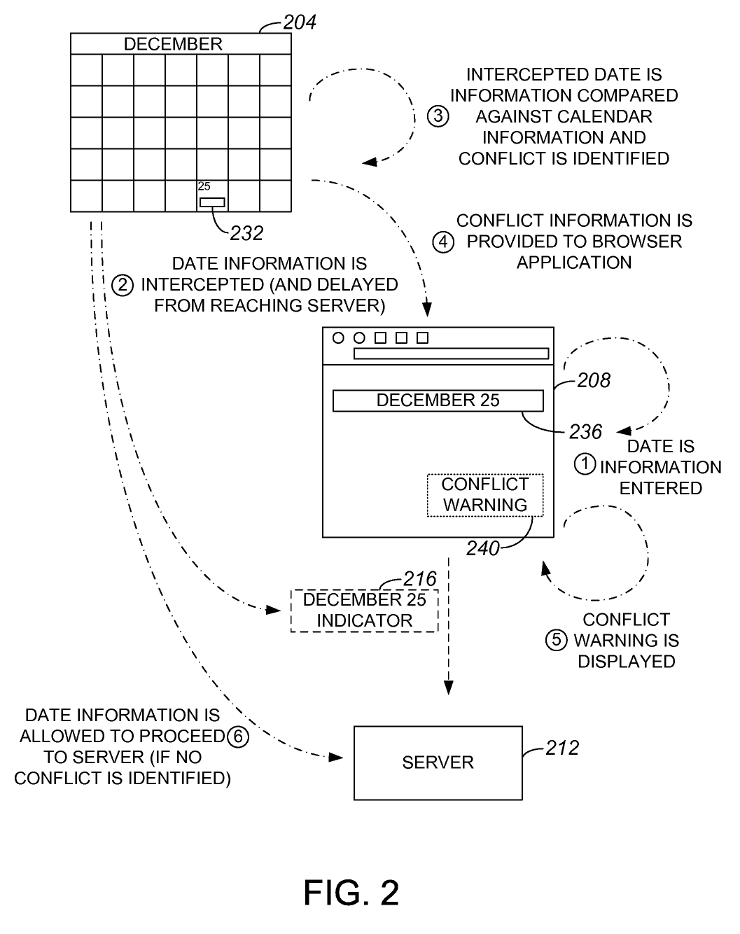

With reference to FIG. 2, a process of providing a calendar conflict warning that may be viewed by an individual interacting with a browser application will be described in accordance with an embodiment of the present invention. An individual with whom a calendar 204 is associated may effectively enter date/time information into a field 236 of a browser application 208. As shown, the date/time information entered into field 236 is date information, e.g., a date of “December 25.” Once the date information is entered in field 236, date information 216 is intercepted and a message which includes date information 216 is substantially delayed or interrupted from reaching server 212. The message which includes date information 216 may be buffered to delay the message from reaching server 212.

Intercepted date information 216 is compared against calendar information in calendar 204. In the described embodiment, date information 216 is intercepted by, and compared to calendar information using, an application which provides calendar 204. It should be appreciated, however, that date information 216 may instead be intercepted by, and compared to calendar information using, a calendar conflict application which has access to calendar 204. For purposes of illustration, a conflict between date information 216 and calendar information in calendar 204 is identified. By way of example, date information 216 conflicts with an event 232 scheduled in calendar 204.

After a conflict is identified, conflict information is provided to browser application 208. The conflict information indicates that date information 216 identifies a date for which event 232 has already been scheduled. Upon receiving the conflict information, browser application 208 displays a conflict warning which effectively warns an individual that the date entered in field 236 is in conflict with event 232.

In the event that no conflict between date information 216 and information associated with calendar 204 is identified, the message containing date information 216 is allowed to proceed to server 212. It should be appreciated, however, that when a conflict is identified, the message containing date information 216 may essentially be discarded.

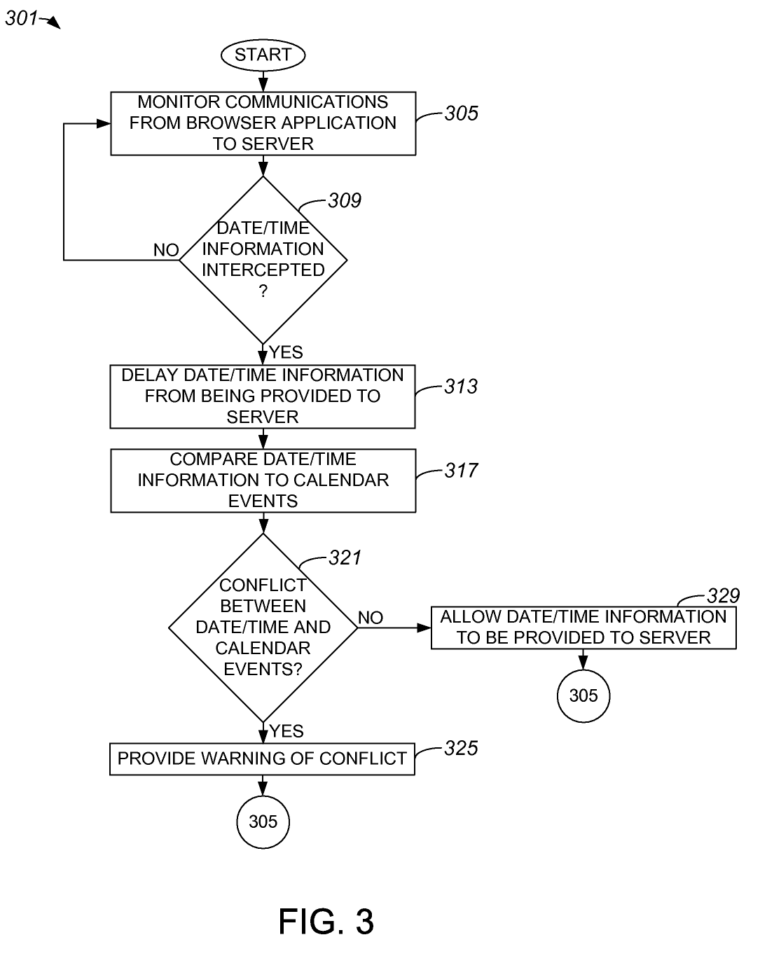

FIG. 3 is a process flow diagram which illustrates a method of processing transmissions from a browser application from the point-of-view of a calendar conflict application in accordance with an embodiment of the present invention. It should be appreciated that the calendar conflict application may either be included substantially as a part of a calendar application, or be substantially separate from a calendar application. A method 301 of processing transmissions from a browser application begins at step 305 in which a calendar conflict application monitors communications or transmissions from a browser application to a server, e.g., a server that is in communications with a browser application through a communications channel such as a network connection. Monitoring communications generally includes intercepting communications such that the communications may be parsed.

A determination is made in step 309 as to whether date/time information has been intercepted. That is, it is determined whether the calendar conflict application has identified a communication from the browser application which includes date/time information. In one embodiment, the date/time information is date/time information that corresponds to a date and/or time that is in the future. If it is determined that no date/time information has been intercepted, then process flow returns to step 305 in which the calendar conflict application continues to monitor communications or transmissions from the browser application.

Alternatively, if it is determined in step 309 that date/time information has been intercepted, the calendar conflict application delays the date/time information from being provided by the browser application to the server in step 313. Delaying the date/time information from being provided to the server may include at least temporarily buffering the overall transmission which includes the date/time information. As previously mentioned, an overall transmission may be a request such as an http request.

Once the date/time information is delayed from being provided to the server, the date/time information is compared to calendar events in step 317. The calendar events may generally be associated with any number of calendar applications to which the calendar conflict application has access. Comparing the date/time information to the calendar events typically includes identifying whether there are any calendar events which occur at or during the date and time specified in the date/time information.

Calendar events, or event data, may be obtained from a calendar application using any suitable method. By way of example, application programming interfaces (APIs) associated with calendar applications or programs may allow a calendar conflict application to obtain the event data. In one embodiment, a calendar conflict application may access an API associated with a calendar application with a request for any calendar events which begin at, end at, and/or encompass a date and/or time indicated in the date/time information. Alternatively, a calendar conflict application may access a file associated with a calendar application to search for event data which correspond to calendar events which begin at, end at, and/or encompass a date and/or time indicated in the date/time information.

After the date/time information is compared to calendar events in step 317, it is determined in step 321 whether there is a conflict between the date and time specified in the date/time information and any calendar events. If it is determined that there is no conflict between the date and time specified in the date/time information and any calendar events, then the date/time information is allowed to be provided to the server in step 329. From step 329, process flow returns to step 305 in which the calendar conflict application monitors communications from the browser application to the server.

Returning to step 321, if the determination is that there is a conflict between the date and time specified in the date/time information and the calendar events, a warning of a conflict is provided in step 325. The warning may be provided such that it is displayed on, or in conjunction with, the browser application. The warning provides an individual, e.g., an individual using the browser application, with information that the current transaction he or she is undertaking using the browser application may result in the scheduling of an event that conflicts with another event that he or she has previously scheduled. After the warning of a conflict is provided in step 325, process flow returns to step 305 in which the calendar conflict application monitors communications from the browser application to the server.

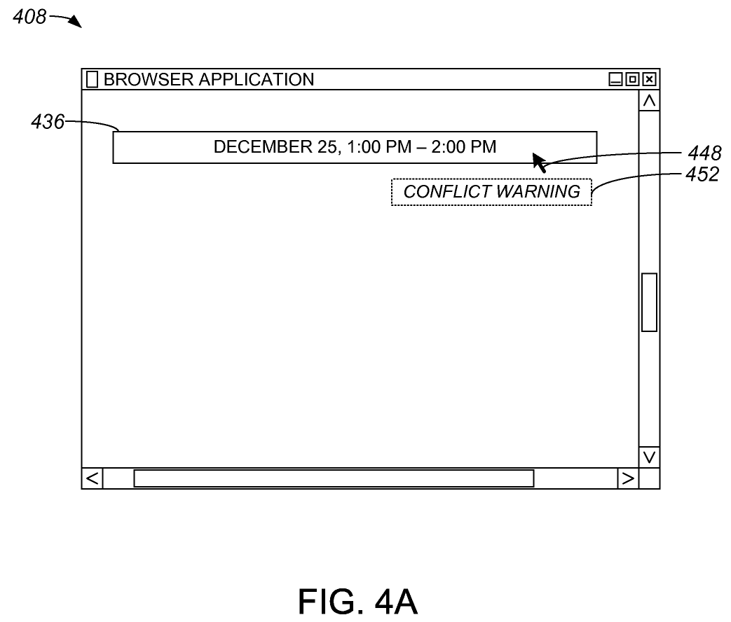

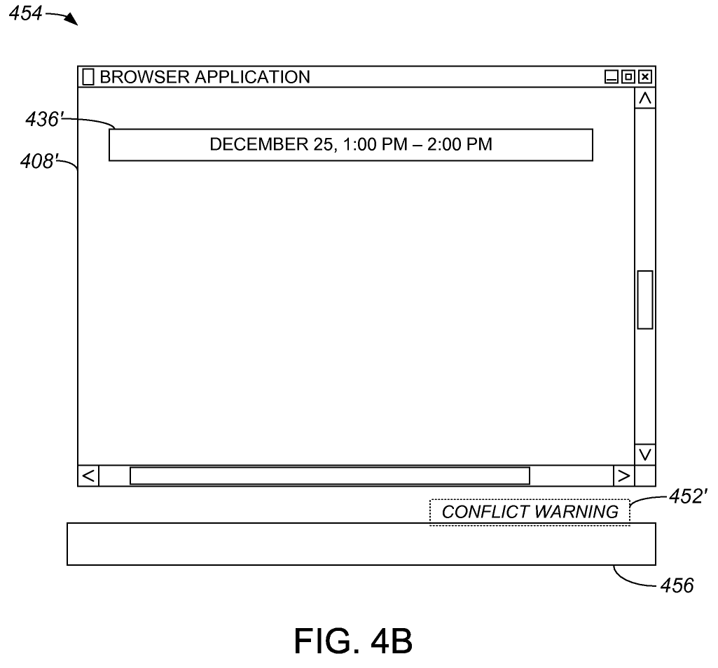

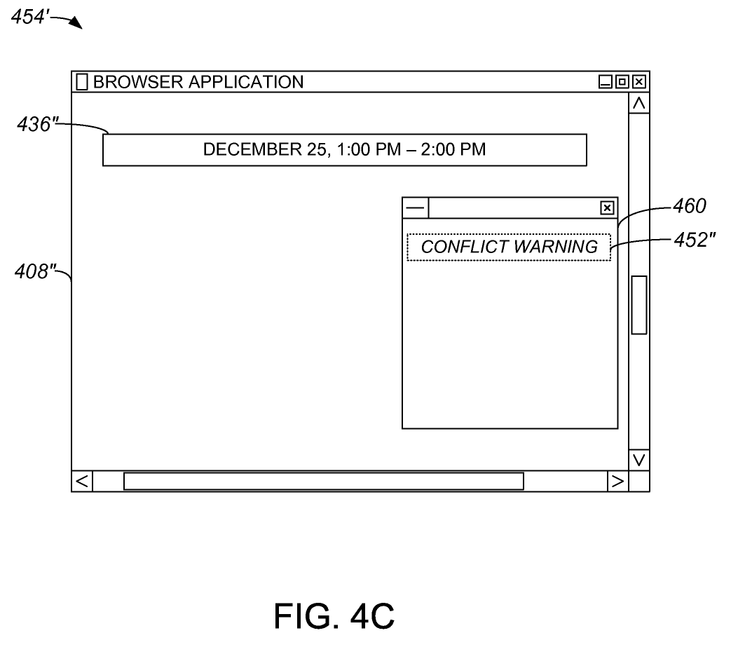

A warning of a conflict, or a conflict warning, is typically displayed with a browser application. The manner in which a conflict warning is displayed may vary widely. With reference to FIGS. 4A-C, examples of conflict warning displays will be discussed in accordance with an embodiment of the present invention. FIG. 4A is a diagrammatic representation of a browser application for which a conflict warning is provided as a pop-up field when a date/time field is activated by a mouse-over in accordance with an embodiment of the present invention. A browser application 408 which may be displayed on a display screen (not shown), e.g., a monitor of a computing system, includes a field 436 which includes date/time information. Field 436 may be a text-entry field or a field associated with a menu. It should be appreciated, however, that field 436 may generally be any suitable field which contains date/time information.

If a conflict between the date/time information entered in field 436 and calendared information (not shown) is identified, a conflict warning 452 may be displayed with respect to browser application 408. As shown, when a cursor 448 is moved over field 436, conflict warning 452 is displayed. For example, when an individual moves a mouse associated with a computing system on which browser application 408 is displayed such that cursor 448 is positioned over field 436, conflict warning 452 is displayed.

In one embodiment, a conflict warning may be displayed with respect to a toolbar displayed on a display screen with a browser application. Referring next to FIG. 4B, a browser application for which a conflict warning is provided as a pop-up substantially in a toolbar will be described in accordance with an embodiment of the present invention. A display 454, which may be associated with a computing system, includes a browser application 408′ and a toolbar 456. When date/time information entered in a field 436′ of browser application 408′ is found to be in conflict with a calendared event (not shown), a conflict warning 452 may be displayed as a pop-up with respect to toolbar 456. Conflict warning 452 may be displayed substantially for any length of time. For example, conflict warning 452 may be displayed until the date/time information in field 436′ is revised such that the date/time information no longer conflicts with a calendared event (not shown), or for a predetermined amount of time.

A conflict warning may also be displayed in a substantially separate window that is displayed in, or with, a browser application. FIG. 4C is a diagrammatic representation of a browser application for which a conflict warning is provided as a pop-up window in accordance with an embodiment of the present invention. A display 454′ includes a browser application 408″ and a pop-up window 460. When information entered in a field 436″ is determined to indicate a conflict with a calendared event (not shown), a pop-up window 460 may open. Pop-up window 460 includes a conflict warning 452″ arranged to alert an individual, e.g., a user interacting with browser application 408″, that information entered in field 436″ is in conflict with a calendared event (not shown). In one embodiment, pop-up window 460 is configured to remain open until an individual closes pop-up window 460.

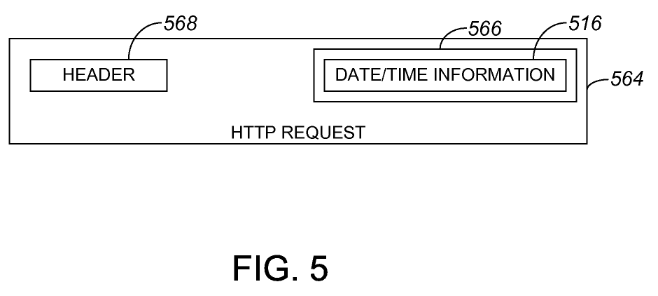

Date/time information may be transmitted or otherwise communicated by a browser application in a variety of different messages. A calendar conflict application may parse a message to identify date/time information. One type of message which may include date/time information is an http request. FIG. 5 is a block diagram representation of an http request which may be transmitted from a browser application to a server. An http request 564 includes a header 568 which may identify http request 564. Typically, a calendar conflict application may obtain header 568 and use information contained in header 568 to identify http request 564.

Http request 564 includes a body 566 which includes information that a browser application is passing to a server. Body 566 includes a field which contains date/time information 516. A calendar conflict application may parse body 566 to substantially extract, or otherwise identify, date/time information 516.

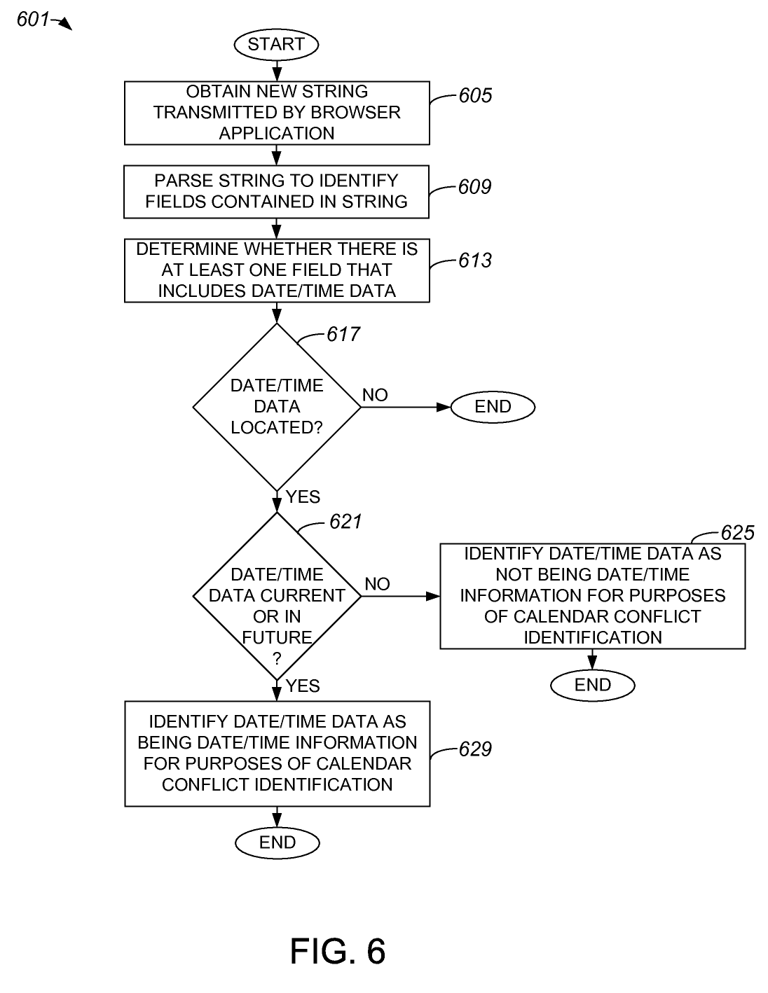

In some instances, date/time data communicated by a browser application may effectively be irrelevant to the identification of calendar conflicts. For example, if date/time data is past information, then comparing the date/time data with calendar events will not result in the identification of current or future calendar conflicts. Hence, if date/time data is past information, the comparison of such information to calendar events may be unnecessary. In one embodiment, if date/time data is past information, the date/time data may be substantially prevented from being processed to determine whether the date/time data conflicts with any calendar events. FIG. 6 is a process flow diagram which illustrates a method of processing date/time data included in a transmission in accordance with an embodiment of the present invention. A method 601 of processing date/time information begins at step 605 in which a new string transmitted by a browser application is obtained, e.g., by a calendar conflict application. The new string may be substantially any message that is transmitted by a browser application and may be, for example, an http request.

Once the new string is obtained, the string is parsed in step 609 to identify fields contained in the string. Then, in step 613, it is determined whether there is at least one field in the string that includes date/time data. That is, any date/time data contained in the new string is identified. The date/time data is substantially any data in the new string which identifies a date and/or a time.

A determination is made in step 617 as to whether date/time data has been located in the new string. If no date/time data is located, the method of processing date/time information is completed. Alternatively, if it is determined that date/time data has been located in the new string, it is determined in step 621 if the date/time data relates to a current or future date and/or time.

If the determination in step 621 is that the date/time data is not current or in the future, the implication is that the date/time data relates to a past date and/or time. As such, in step 625, the date/time data is identified as not being date/time information or the purposes of calendar conflict identification, and the method of processing date/time data is completed.

On the other hand, if it is determined in step 621 that the date/time data pertains to a current or future date and/or time, the indication is that the date/time data is date/time information for the purposes of determining whether there is a conflict with a calendar event. Accordingly, in step 629, the date/time data is identified as being date/time information for the purposes of calendar conflict identification, and the processing of date/time data is completed.

In general, a calendar conflict application or daemon is configured before it is used. A calendar conflict application may be provided with information which allows the calendar conflict application to access a calendar application. In other words, an individual may grant permissions for a calendar conflict application to access calendars maintained by the individual. An individual may grant permissions by providing login information, and passwords as appropriate, to a calendar conflict application such that the calendar conflict application may access any number of calendar applications used by the individual.

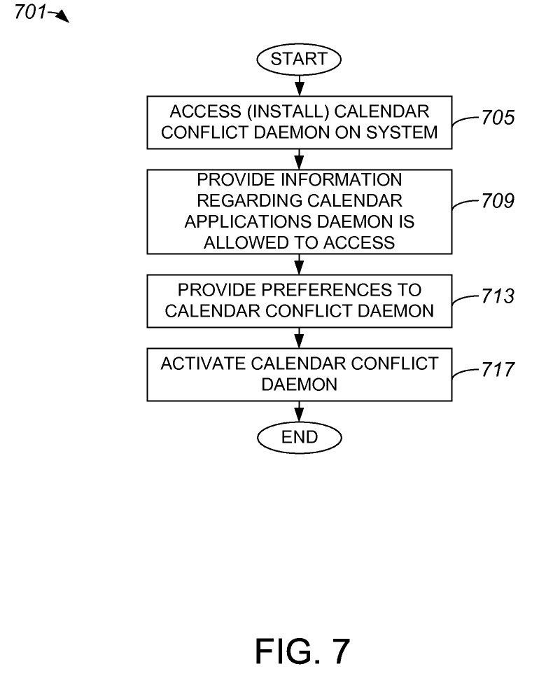

FIG. 7 is a process flow diagram which illustrates a method of configuring a calendar conflict application or daemon in accordance with an embodiment of the present invention. It should be appreciated that although a calendar conflict daemon is described, a calendar application may generally include conflict warning logic that allows the calendar application to access other calendar applications. A process 701 of configuring a calendar conflict daemon begins at step 705 in which a calendar conflict daemon is accessed, e.g., installed, on a system.

Once the calendar conflict daemon is installed, the calendar conflict daemon may be granted permissions in step 709. For example, the calendar conflict daemon may be provided with information regarding calendar applications which the calendar conflict daemon is to access when identifying calendar conflicts. Such information may include, but is not limited to including, login information, passwords, universal record locater (URL) addresses, and the like for calendar applications. It should be appreciated that information which identifies specific calendar applications to be excluded from use when identifying calendar conflicts may also be provided.

In step 713, the calendar conflict daemon is provided with preferences. For instance, the calendar conflict daemon may be provided with preferences which indicate the manner in which to display conflict warnings. After preferences are provided to the calendar conflict daemon, the calendar conflict daemon is activated in step 717, and the process of configuring a calendar conflict daemon is completed.

Although only a few embodiments of the present invention have been described, it should be understood that the present invention may be embodied in many other specific forms without departing from the spirit or the scope of the present invention. By way of example, while a user of an application such as a browser application may generally schedule an event even after receiving a warning that the event conflicts with another event, a user may instead effectively be prevented from scheduling a conflicting event. That is, a calendar conflict application may be configured to essentially prevent an individual from completing a transaction that would result in the scheduling of a conflicting event.

When a conflict warning is displayed with respect to a toolbar, the conflict warning may be displayed as a pop-up, e.g., as discussed above with respect to FIG. 4B. It should be appreciated, however, that a conflict warning displayed with respect to a toolbar may instead be displayed substantially directly on the toolbar. In other words, a conflict warning may be displayed on a toolbar or as a pop-up with respect to the toolbar.

Conflict warnings or alerts may be provided as a relatively small pop-up, as previously mentioned. Such a pop-up may be associated with a system tray, e.g., a Windows system tray operating with respect to a computing system. A pop-up may include a list of events that occur at or during a date and/or time that is specified in a browser application. Each conflicting event identified in the list may be clickable such that selecting the conflicting event may open a calendar entry relating to that conflicting event.

In one embodiment, the ability to effectively ignore a conflicting calendar event may be provided in a conflict warning. That is, an individual may be provided with the ability to substantially indefinitely ignore a conflict warning. For example, an individual attempting to schedule an activity during a week in which his or her calendar indicates a weeklong visit from a friend may elect to effectively prevent conflict warnings from being generated with regards to events which conflict with the visit, as the individual may still attend events while the friend is visiting. An interface may be provided in a conflict warning the first time a conflict with a calendared event is identified to allow an individual to elect not to be warned of future conflicts with the calendared event.

While calendar conflict warnings have been described as being provided either by a calendar application or a standalone application, calendar conflict warnings are not limited to being provided either by a calendar application or a standalone application. For instance, a browser application may be arranged in one embodiment to identify date/time information and to compare the date/time information to calendar information in order to determine whether there is a conflict.

A calendar conflict application may compare date/time information obtained from a browser application to events from any number of calendars. Generally, an individual may provide information to a calendar conflict application that identifies the calendar applications which may be searched to identify calendar events against which date/time information obtained from a browser application may be compared. Such calendar applications may be associated with personal calendars, e.g., calendars owned by the individual, and/or shared calendars. It should be appreciated that appropriate permissions are typically obtained by a calendar conflict application before personal and shared calendars may be accessed by the calendar conflict application.

In one embodiment, a conflict warning may include an indication of the source of the conflict. That is, a conflict warning may identify an actual event that is scheduled on a calendar. By way of example, if an individual is attempting to purchase a vacation for a particular week through a browser application and a calendar conflict application identifies a meeting that the individual has scheduled during that particular week, a conflict warning may identify the meeting as being scheduled during that particular week. Hence, in addition to being warned of a conflict, an individual may be provided with information that allows the individual to identify the actual conflict.

A conflict warning has generally been described as being a substantially visual warning. It should be appreciated, however, that a conflict warning is not limited to being a visual warning. A conflict warning may be an audio warning, or a visual warning with an audio component. For instance, a conflict warning may include an audio alarm, e.g., a “beep,” which sounds when a calendar conflict is identified.

Date/time information which is transmitted from a browser application to a server may be associated with a variety of different activities. In other words, date/time information may be generated for a variety of different purposes associated with a browser application. By way of example, date/time information may be generated as a result of an attempt to purchase tickets to a date and/or time sensitive event, or as a result of an attempt to schedule an event such as a meeting or a vacation.

An individual or user of a browser application which is capable of generating a conflict warning may manually request a conflict check. That is, a user may request a conflict warning check for a particular date and/or time. For instance, as a user is contemplating purchasing tickets to a date and/or time sensitive event, he or she may request a conflict check. A conflict check may be requested by making a selection from a browser menu, by clicking on a button on a browser screen, and the like. When the user manually requests a conflict check, a conflict warning may be generated if the date and/or time identified by the user in conflict with an event that is already scheduled on a calendar associated with the user.

When a calendar conflict check is performed, time differences may substantially automatically be accounted for. In other words, time differences may be accounted for such that the time of each scheduled event is effectively converted to a particular time zone. The time zone to which each calendar event may effectively be transformed into may be the time zone in which a user is located such that a calendar conflict check may be accurately performed.

In one embodiment, a user may attempt to fill in a form, e.g., a form presented within a browser window, with a time and/or a date. Any date and/or time filled in by the user may be subject to a calendar conflict check in accordance with the present invention.

The present invention may be implemented as hardware and/or software logic embodied in a tangible medium that, when executed, is operable to perform the various methods and processes described above. For example, the logic that enables transmissions sent by a browser application to be monitored such that conflict warnings may be provided may be implemented as hardware logic, software logic, or a combination of both hardware and software logic.

The steps associated with the methods of the present invention may vary widely. Steps may be added, removed, altered, combined, and reordered without departing from the spirit of the scope of the present invention. Therefore, the present examples are to be considered as illustrative and not restrictive, and the invention is not to be limited to the details given herein, but may be modified within the scope of the appended claims.

What is claimed is:

1. A method comprising:
obtaining a transmission, the transmission being sent by a first application;
determining whether the transmission includes date/time information;
comparing the date/time information to information associated with at least a second application when it is determined that the transmission includes the date/time information;
determining if the date/time information conflicts with the information associated with the second application; and
providing a conflict warning if it is determined that the date/time information conflicts with the information associated with the second application.

2. The method of claim 1 wherein the first application is a browser application.

3. The method of claim 1 wherein the first application is associated with a first system, and wherein providing the conflict warning includes providing the conflict warning to the first system.

4. The method of claim 3 wherein the first system displays the conflict warning.

5. The method of claim 1 wherein the second application is a calendar application, and wherein determining if the date/time information conflicts with the information associated with the calendar application includes determining whether the date/time information conflicts with an event identified in the calendar application.

6. The method of claim 1 further including:
monitoring a communications channel associated with the first application, wherein obtaining the transmission includes obtaining the transmission from the communications channel.

7. The method of claim 6 wherein determining whether the transmission includes the date/time information includes parsing the transmission.

8. The method of claim 1 further including:
preventing the transmission from reaching a server when it is determined that the date/time information conflicts with the information associated with the second application.

9. Logic encoded in one or more tangible media for execution and when executed operable to:
obtain a transmission, the transmission being sent by a first application;
determine whether the transmission includes date/time information;
compare the date/time information to information associated with at least a second application when it is determined that the transmission includes the date/time information;
determine if the date/time information conflicts with the information associated with the second application; and
provide a conflict warning if it is determined that the date/time information conflicts with the information associated with the second application.

10. The logic of claim 9 wherein the first application is a browser application.

11. The logic of claim 9 wherein the first application is associated with a first system, and wherein providing the conflict warning includes providing the conflict warning to the first system.

12. The logic of claim 11 wherein the first system displays the conflict warning.

13. The logic of claim 9 wherein the second application is a calendar application, and wherein the logic operable to determine if the date/time information conflicts with the information associated with the calendar application is operable to determine whether the date/time information conflicts with an event identified in the calendar application.

14. The logic of claim 9 further operable to:
monitor a communications channel associated with the first application, wherein the logic operable to obtain the transmission is further operable to obtain the transmission from the communications channel.

15. The logic of claim 14 wherein the logic operable to determine whether the transmission includes the date/time information is further operable to parse the transmission.

16. The logic of claim 9 further operable to:
prevent the transmission from reaching a server when it is determined that the date/time information conflicts with the information associated with the second application.

17. An apparatus comprising:
means for obtaining a transmission, the transmission being sent by a first application;
means for determining whether the transmission includes date/time information;
means for comparing the date/time information to information associated with at least a second application when it is determined that the transmission includes the date/time information;
means for determining if the date/time information conflicts with the information associated with the second application; and
means for providing a conflict warning if it is determined that the date/time information conflicts with the information associated with the second application.

18. An apparatus comprising:
an information monitor, the information monitor being arranged to monitor at least a first application to identify a transmission that includes a date/time indication, the transmission being associated with the first application;
a first conflict warning arrangement, the first conflict warning arrangement being arranged to access a second application and to compare the date/time indication with information associated with the second application to determine whether the date/time indication conflicts with the information associated with the second application; and
a second conflict warning arrangement, the second conflict warning arrangement being arranged to provide a conflict warning when it is determined that the date/time indication conflicts with the information associated with the second application.

19. The apparatus of claim 18 wherein the second conflict warning arrangement is arranged to provide the conflict warning to the first application.

20. The apparatus of claim 18 wherein the second application is a calendar application and the information is associated with an event scheduled in the calendar application.

21. The apparatus of claim 19 wherein the first application is a browser application.

22. The apparatus of claim 18 wherein the first warning conflict arrangement is further arranged to access a third application and to compare the date/time indication with information associated with the third application to determine whether the date/time indication conflicts with the information associated with the third application.
